(19) United States
(12) Patent Application Publication
(10) Pub. No.: US 2024/0090084 A1
(43) Pub. Date: Mar. 14, 2024

(54) APPARATUS AND METHOD FOR HEATING MASSES WITH ELECTRIC CURRENT

(71) Applicant: DIL Deutsches Institut für Lebensmitteltechnik e.V., Quakenbrück (DE)

(72) Inventors: Martin Stute, Quakenbrück (DE); Frank Schilling, Quakenbrück (DE); Eike Joeres, Quakenbrück (DE); Nino Terjung, Quakenbrück (DE)

(21) Appl. No.: 18/462,822

(22) Filed: Sep. 7, 2023

(30) Foreign Application Priority Data
Sep. 9, 2022 (DE) 102022209464.6

(51) Int. Cl. H05B 3/00

(52) U.S. Cl. CPC H05B 3/0004

(57) ABSTRACT

A device for applying electric current to mass. The device includes a vessel having a cylindrical wall with a stirrer arranged in the vessel. The stirrer is mounted on a first end of a rotationally driven stirrer shaft. The stirrer shaft with a spacing is enclosed by a first electrode. The first electrode is immobile and fixed to a lid arranged to cover an open cross-section of the vessel. The cylindrical wall forms a second electrode, wherein the first electrode and the second electrode are connectable to opposite polarities of a current source.

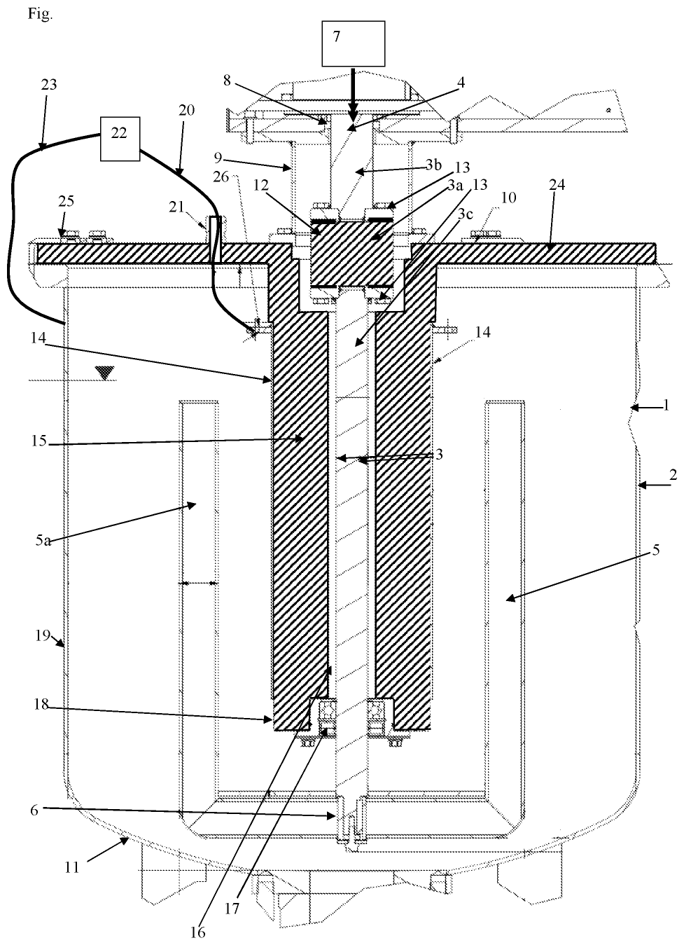

### PRIORITY CLAIM

This application claims priority under 35 U.S.C. § 119 and all applicable statutes and treaties from prior German Application No. DE 102022209464.6, which was filed Sep. 9, 2022.

### FIELD OF THE INVENTION

A field of the invention concerns devices that can heat and stir mass in as vessel. An example application of a device is to heat a food mass containing water.

### SUMMARY OF THE INVENTION

A preferred embodiment is device for applying electric current to mass. The device includes a vessel having a cylindrical wall with a stirrer arranged in the vessel. The stirrer is mounted on a first end of a rotationally driven stirrer shaft. The stirrer shaft with a spacing is enclosed by a first electrode. The first electrode is immobile and fixed to a lid arranged to cover an open cross-section of the vessel. The cylindrical wall forms a second electrode, wherein the first electrode and the second electrode are connectable to opposite polarities of a current source.

### BRIEF DESCRIPTION OF THE DRAWING

The FIGURE shows a cross-sectional view of a preferred embodiment of the present invention in longitudinal section along the stirrer shaft.

### DETAILED DESCRIPTION OF THE PREFERRED EMBODIMENTS

The present invention relates to an apparatus and a method, which can be carried out with the apparatus, for heating masses with electric current. The apparatus comprises a stirring vessel, which has a stirrer, the shaft of which is preferably arranged coaxially with the central axis of the vessel. Preferably, the vessel is cylindrical.

The device has the advantage of comprising electrodes to which electric current can be applied without passing electric current between parts moving relative to each other. Preferably, the electrodes are connected to a power source which delivers electric current to the electrodes for resistive heating, for example alternating current, at a power suitable for heating the mass in the stirring vessel. Preferably, a food mass, especially a food mass containing water is heated in the vessel by applying electrical current to the electrodes.

The invention has the object of providing a device and a method, which can be carried out thereby, for heating masses with electric current, by which masses can be heated in batches while being stirred, the current preferably not being transmitted between parts moving relative to one another.

The invention provides a device comprising a vessel of cylindrical cross-section, the vessel having a bottom and a lid covering the cross-section of the vessel with respect to the bottom, the device having an stirrer shaft disposed axially in the vessel and a stirrer attached to the stirrer shaft, wherein the stirrer is attached to a first end of the stirrer shaft, which stirrer shaft in at least one section is made of insulator material, with a drive engaging the second end of the stirrer shaft opposite its first end, wherein the stirrer shaft, in the region extending between its first and second ends, is enclosed by a first electrode spaced from the stirrer shaft, which first electrode is immobile and fixed to the lid, the gap formed by the spacing between the stirrer shaft and the first electrode being sealed at least to the first end of the stirrer shaft, preferably sealed also to the second end of the stirrer shaft, the cylindrical wall of the vessel forming a second electrode, with a current source whose terminals of opposite polarities are connected to one each of the first and second electrodes.

The invention achieves the object by the features of the claims and provides a device for heating of a mass by applying electric current to the mass, the device comprising or consisting of a stirring vessel of cylindrical cross-section, with a bottom and a lid covering the cross-section of the vessel opposite the bottom, with a stirrer shaft arranged axially to the vessel and a stirrer attached thereto,

wherein the stirrer is attached to a first end of the stirrer shaft, which in at least one section is made of an insulator material, with a drive for rotating the stirrer shaft, the drive engaging the second end of the stirrer shaft opposite the first end,
wherein the stirrer shaft, in the region extending between its first end and its second end, is enclosed with a spacing by a first electrode, wherein the first electrode is immobile and fixed to the lid,
wherein the gap formed by the spacing of the stirrer shaft from the first electrode is sealed at least to the first end of the stirrer shaft, preferably also to the second end of the stirrer shaft, preferably with an insulator tube arranged between the first electrode and the stirrer shaft, which insulator tube is preferably fixed to the lid, and which insulator tube further preferably abuts the first electrode and is spaced from the stirrer shaft by a gap,
the cylindrical wall of the vessel forming a second electrode,
a current source whose terminals of opposite polarity are connected to one each of the first and second electrodes.

The invention further relates to a method for applying electric current to a mass, in which the mass is filled into the vessel until the mass contacts both the first electrode and the second electrode, e.g. with the stirrer stationary or with the stirrer rotating, and electric current of opposite polarity is applied to the electrodes, while the stirrer is driven to rotation.

The first electrode is fixed to the lid, preferably the insulator tube to the outside of which the first electrode is fixed, is fixed to the lid. Accordingly, the first electrode, and preferably the insulator tube, are immovably fixed to the lid, with the stirrer shaft being rotatably arranged with a spacing inside the first electrode, preferably the stirrer shaft is arranged with a spacing inside the insulator tube. According to the invention, the first electrode is stationary to the lid and the second electrode, being formed by the wall of the vessel, is stationary both to the vessel and stationary to the first electrode.

The current source can be arranged to introduce electrical energy that heats the volume of the mass between the electrodes in a short time, preferably within a few minutes.

The device has the advantage that the electrodes are connected to the current source by fixed connections, e.g. fixed cables or conductor rails, and the device does not require any transmission of electric current between elements moving relative to one another or moving against each other, in particular in particular does not have sliding contacts.

The first electrode is preferably cylindrical and is arranged coaxially with the cylindrical wall of the vessel, the wall of the vessel preferably forming the second electrode, so that the first and second electrodes are arranged at the same spacing over the cross-section of the vessel and are set up for a uniform flow of electrical current across the cross-section of the vessel and along the length of the first and second electrodes. Optionally, the stirring vessel may contain baffles, preferably baffles consisting of insulator material.

The stirrer is preferably a stirrer having stirrer arms moving in the space between the first and second electrodes, e.g., an anchor stirrer having the stirrer arm driven along a coaxial circular path in the interspace between the electrodes.

The stirrer shaft may consist entirely of insulator material, or may consist of insulator material in at least one axial shaft section, e.g. one axial insulator section of the shaft, adjacent to at least one axial shaft section of metal. Therefore, the stirrer shaft is preferably electrically non-conductive so that electric current cannot flow from the stirrer shaft to its drive, even if the drive is electrically conductive, e.g., is at least partially made of electrically conductive material, e.g., has an electrically conductive housing and/or electrically conductive gear.

The stirrer may consist of electrically conductive material, e.g., metal, in particular stainless steel. Optionally, the stirrer has arms of electrically conductive material extending into the interspace between the electrodes, wherein preferably a section of the stirrer between its arms and the stirrer shaft is electrically non-conductive, e.g. the stirrer shaft comprises a section consisting of insulator material.

The bottom of the vessel is optionally electrically non-conductive, e.g. consists of electrically non-conductive material or comprises or consists of metal with a coating of an electrical insulator material. Preferably, the bottom of the vessel is made of metal, e.g. of stainless steel, in particular formed integrally with the cylindrical wall. In this regard, the device has the advantage that the vessel can be a conventional vessel made of metal to which are attached the lid and thereon the stirrer with a drive and the immobile first electrode. Therefore, the invention also provides a method of manufacturing the device of the invention in which method an electrical connection to a polarity of a power source is attached to a vessel made of metal with a cylindrical wall to form the second electrode of the wall of the vessel, and a lid with an immobile first electrode attached, a stirrer shaft with a drive and a stirrer, according to the invention, is attached to the cross-sectional opening opposite the bottom.

The lid is electrically non-conductive between its bearing area, by which it rests against the cylindrical wall of the vessel, in particular on an end face of the vessel, which end face may be a flange, directly or with an intermediate seal or gasket, and the lid having a central area, in which the stirrer shaft is arranged through the lid. The lid may be made of insulating material and on its bearing area may have connection pieces, for example terminals, which may be made of metal and which are spaced from the central area. A leadthrough with an electrical lead passing through is arranged in the lid, to which electrical lead the first electrode is connected. Preferably, the first electrode has a connection lug or a connecting flange for the electrical lead, which may be, for example, a shielded coaxial cable. Optionally, a transparent section is arranged in the lid, or the lid is made of transparent insulator material. The lid may have at least one opening, which is preferably closable, as an inlet and/or outlet.

In general, any insulator material can form any element consisting of insulator material or a coating of insulator material, each insulator material being a different or the same material, e.g., selected from electrically non-conductive plastics, ceramics, or glass, e.g., polypropylene, polycarbonate, polyester, polyamide, glass, aluminum oxide, enamel, or combinations of at least two of these.

Preferably, the first electrode is spaced from the lid, further preferably the spacing of the first electrode from the lid is completely covered by an insulator tube extending, for example, between the lid and the first electrode and preferably sealingly abutting both of these.

Preferably, the stirrer is exclusively attached to the first end of the stirrer shaft. The stirrer shaft is rotatably run on bearings at least, optionally exclusively, at its second end, for example run on bearings in the axial region between the drive and an open cross-section of the vessel which is covered by a lid, for example run on bearings in the axial region between the drive and the lid.

In a preferred embodiment, an insulator tube, e.g. of electrically non-conductive material, is arranged between the first electrode and the stirrer shaft, which further preferably abuts the first electrode and is spaced from the stirrer shaft by an annular gap. Therein, the insulator tube may support the first electrode, in particular abutting and/or adjoining the inner side of the first electrode. A portion of the insulator tube may extend beyond the first electrode to adjacent the lid. Optionally, the stirrer shaft is rotatably supported on the insulator tube in the region of its first end, e.g. by a rolling bearing, preferably with a seal, e.g. a gasket, covering the gap between the stirrer shaft and the insulator tube.

The first electrode, which is preferably generally cylindrical, may have recesses or be circumferentially closed and preferably rests on the insulator tube. The first electrode, especially if it has recesses, can rest positively on the insulator tube so that the insulator tube fills recesses of the first electrode, e.g. such that the insulator tube with the first electrode forms a continuous surface, e.g. a cylindrical and/or smooth surface without protrusions or recesses.

The gap between the stirrer shaft and the first electrode is preferably covered in the region of the first end, optionally additionally or alternatively the gap in the region of the second end of the stirrer shaft is preferably covered by a seal, for example by an electrically non-conductive floating ring seal, which covers the gap between the first electrode and the stirrer shaft, optionally between the insulator tube and the stirrer shaft.

The invention will now be described with reference to the FIGURE, which shows a preferred embodiment of the device in longitudinal section along the stirrer shaft.

The vessel 1 has a cylindrical wall 2 in which the stirrer shaft 3 is arranged, as preferred coaxially arranged, the first end 4 of which stirrer shaft 3 is connected to a stirrer 5 and the opposite second end 6 of which stirrer shaft 3 is connected to a drive 7 for rotating the stirrer shaft 3. The stirrer shaft 3 may be rotatably run on bearings at its second end 6 in a bearing 8, which is connected to the lid 10 by a housing 9 with a spacing, wherein the lid 10 covers a terminal cross-sectional opening of the vessel 1 opposite its bottom 11. The bottom 11 as shown here is formed in one piece with the wall 2. The stirrer shaft 3 is electrically non-conductive in that it has an insulator section 3a, which in the variant shown here is a plastic piece 12 forming an axial section between the first end 4 and the second end 6 of the stirrer shaft 3. As is generally preferred, the insulator section 3a extends at least over the region in which the stirrer shaft 3 traverses and passes through the lid 10. The insulator section 3a may be connected by screw connections 13 on the one hand to a drive section 3b of the stirrer shaft 3 and on the other hand to an end section 3c of the stirrer shaft 3. Alternatively, the insulator section 3a and the end section 3c may be formed of insulator material, optionally in one piece, or the stirrer shaft 3 may be formed entirely of insulator material, preferably in one piece.

The stirrer shaft 3 is enclosed over an axial section between its first end 4 and its second end 6 by a spaced-apart first electrode 14, wherein between the stirrer shaft 3 and the first electrode 14 there is arranged an insulator tube 15 which is spaced from the stirrer shaft 3 by a gap 16 and against which the first electrode 14 adjoins over its entire surface. The gap 16 is covered by a seal 17 at the first end 18 of the insulator tube 15, which seal 17 in the embodiment shown herein is attached to the insulator tube 15, the stirrer shaft 3 being rotatably guided in the seal 17. The insulator tube 15 is fixed immobile to the lid 10. The first electrode 14, which lies directly on the insulator tube 15 is fixed immobile at the lid 10.

The cylindrical wall 2 of the vessel 1 forms the second electrode 19, which is spaced apart and arranged concentrically around the first electrode 14. In the interspace between the electrodes 14, 19, the stirrer 5 is movable on a circular path concentric to the electrodes 14, 19. The first electrode 14 is connected, e.g. by a connection lug 26, to one polarity of a current source 22 by an electrical lead 20, which is passed through a bushing forming a leadthrough 21 in the lid 10, and the second electrode 19 is connected to the other polarity of the current source 22 by an electrical lead 23.

In the variant shown here, the stirrer 5 is an anchor stirrer whose stirrer arms 5a are driven along a circular path between first and second electrodes 14, 19. In this variant, the stirrer 5 is made of electrically conductive material, in particular of stainless steel.

The lid 10 is electrically non-conductive and consists essentially of a plastic plate 24, to the periphery of which clamps 25 are attached, by which the lid 10 is pressed against the end face 2a of the wall 2.

### REFERENCE SIGNS

1 vessel
2 wall
2a end face of the wall
3 stirrer shaft
3a insulator section of stirrer shaft
3b drive section of stirrer shaft
3c end section of stirrer shaft
4 first end of stirrer shaft
5 stirrer
5a stirrer arm
6 second end of stirrer shaft
7 drive
8 bearing
9 housing
10 lid
11 bottom
12 plastic piece
13 screw connection
14 first electrode
15 insulator tube
16 gap
17 seal
18 first end of insulator tube
19 second electrode
20 electrical lead
21 leadthrough, bushing
22 current source
23 electrical lead
24 plastic plate
25 clamp
26 connection lug

1. A device for applying electric current to mass, comprising a vessel having a cylindrical wall with a stirrer arranged in the vessel, the stirrer being mounted on a first end of a rotationally driven stirrer shaft. wherein the stirrer shaft with a spacing is enclosed by a first electrode, which first electrode is immobile and fixed to a lid arranged to cover an open cross-section of the vessel. and the cylindrical wall forms a second electrode, wherein the first electrode and the second electrode are connectable to opposite polarities of a current source.

2. The device according to claim 1, wherein an insulator tube is arranged between the first electrode and the stirrer shaft, the first electrode abutting the insulator tube and which insulator tube is spaced from the stirrer shaft by a gap and is fixed to the lid.

3. The device according to claim 1, wherein a gap formed by the spacing between the stirrer shaft and the first electrode is sealed at the first end of the stirrer shaft.

4. The device according to claim 1, wherein the lid covers a terminal cross-sectional opening of the vessel, which lid is electrically non-conductive, which lid rests on an end face of the wall of the vessel and has a lead through which an electrical lead is passed which connects the first electrode to a current source.

5. The device according to claim 1, wherein the stirrer shaft in at least one axial insulator section consists of insulator material.

6. The device according to claim 1, wherein the axial insulator section of the stirrer shaft extends at least over the region in which the stirrer shaft passes through the lid.

7. The device according to claim 6, wherein the insulator section of the stirrer shaft is connected to a drive section of the stirrer shaft connected to the drive and to an end section of the stirrer shaft, the drive section and the end section being made of metal.

8. The device according to claim 6, wherein the insulator section of the stirrer shaft is connected to a drive section of the stirrer shaft connected to the drive (7) and to an end section of the stirrer shaft, the drive section and the end section being made of metal.

9. The device according to claim 1, wherein the stirrer is an anchor stirrer having stirrer arms movable along a circular path in the interspace between the first electrode and the second electrode.

10. The device according to claim 1, wherein the first electrode and the second electrode are concentric to one another.

11. The device according to claim 1, wherein the spacing between the first electrode and the lid is completely covered by an insulator tube which adjoins the lid.

12. A method of manufacturing a device according to claim 1, comprising arranging a lid to which a rotationally driven stirrer shaft is attached, on a vessel having a cylindrical wall, at the first end of which stirrer shaft a stirrer is mounted, wherein the stirrer shaft with a spacing is enclosed by a first electrode which is fixed immobile to the lid, connecting the cylindrical wall to one polarity of a current source to form a second electrode of the wall, and connecting the first electrode to an opposite polarity of the current source.

13. The method according to claim 12, wherein between the first electrode and the stirrer shaft an insulator tube is arranged, which insulator tube is fixed immobile to the lid, against which insulator tube the first electrode adjoins and which insulator tube is spaced from the stirrer shaft by a gap.

14. A method of applying electric current to a mass by filling the mass into the vessel of a device according to claim 1, driving the stirrer to rotate and applying current of opposite polarities to the first electrode) and the second electrode.
